(19) United States
(12) Patent Application Publication
(10) Pub. No.: US 2026/0152316 A1
(43) Pub. Date: Jun. 4, 2026

(54) PACKAGING BOX SHOWING DIFFERENT OPEN AND CLOSED IMAGES, METHOD OF PREPARING THE SAME, AND APPLICATIONS OF THE SAME

(71) Applicant: CHINA TOBACCO YUNNAN INDUSTRIAL CO., LTD., Kunming (CN)

(72) Inventors: Xi YANG, Kunming (CN); Ran TIAN, Kunming (CN); Hui LI, Kunming (CN); Zhijiang YIN, Kunming (CN); Wenyuan WANG, Kunming (CN); Ji YANG, Kunming (CN); Ying WU, Kunming (CN)

(21) Appl. No.: 19/439,299

(22) Filed: Jan. 3, 2026

Related U.S. Application Data
(63) Continuation of application No. PCT/CN2025/106979, filed on Jul. 4, 2025.

(30) Foreign Application Priority Data
Dec. 3, 2024 (CN) 202411755794.2

(51) Int. Cl. B65D 5/42; B31B 50/62; B31B 50/83; B31B 120/60; B65D 5/38

(52) U.S. Cl. CPC B65D 5/425; B31B 50/62; B31B 50/83; B65D 5/38; B65D 5/4204; B31B 2120/60; B31B 2241/003

(57) ABSTRACT

The present invention discloses a packaging box that displays different images when open and closed, which comprises an outer box body and an inner box body. A display window is provided on the upper face of the outer box body. Different images are displayed in the display window on the unfolded surface or the closed surface. The unfolded surface is fixed in the display window. Opening and closing the inner box body drives the lateral movement of the closed surface to display the image on the unfolded surface or the image on the closed surface in the display window. The invention also discloses a preparation method and application of the packaging box.

### TECHNICAL FIELD

The present invention relates to the technical field of packaging, and specifically relates to a novel packaging box that shows different images when open and closed, a method of preparing the same, and applications of the same.

### BACKGROUND

In response to the cigarette product development requirements of enhancing consumer sensory experience, improving cigarette brand recognition and creating new product selling points, cigarette packaging has developed a multimodal interactive packaging structure design technology by studying the multimodal interaction methods of consumers at three different demand levels: the basic layer, the composite layer, and the intelligent layer. Therefore, in order to increase product competitiveness, innovations in cigarette packaging boxes may focus on multimodal interactive cigarette packaging structure design technology and provide consumers with a product experience that integrates visual, tactile, auditory, and emotional connections, as well as other interactive functions.

Chinese Patent CN2020101130671 discloses a technical solution in which the front pattern of the outer box appears in different layers that alternate with each other. But the patent may not fully disclose a complete solution, and its functions and effects may not be fully realized according to the disclosed technical solution, such as how presentation part A and presentation part B are misaligned and how presentation part B moves along with the inner box body, etc. Second, the presentation component of the patent requires an envelope, and slats are also provided on sides of the inner box body; that is, the inner box body needs two layers of walls on the sides. This increases the amount of production material used, and accordingly increases its production cost. Third, the setting of the upper limit slot of the slat in the patent increases the volume of its inner and outer boxes, which increases the difficulty of calculating the inner control size of the small cigarette packaging box (generally 10 packs). At the same time, it increases the amount of production material used, and accordingly increases its production cost.

### SUMMARY

To solve the technical problems mentioned above, the present invention concerns a packaging box that shows different images when open and closed, and is used in cigarette packaging boxes, such as cartons. The present invention presents two dynamic images when the inner box body is opened and closed, with a novel spatial dynamic experience and a strong visual impact.

The technical solution of the present invention is as follows:

A first aspect of the present invention concerns a packaging box that shows different images when open and closed, which comprises an outer box body and an inner box body; a display window on an upper face of the outer box body; and different images displayed in the display window on an unfolded surface (e.g., when the packaging box is open) and a closed surface (e.g., when the packaging box is closed); where the unfolded surface is fixed in the display window; and opening and closing the inner box body drives lateral movement of the closed surface to display the image on the unfolded surface (e.g., when the packaging box is open) or the image on the closed surface in the display window (e.g., when the packaging box is closed).

Preferably, the unfolded surface has first and second (e.g., upper and lower) edges that are bonded to an unfolded surface frame body, and the unfolded surface frame body has first and second (e.g., upper and lower) edges that are bonded to an upper wall of the outer box body, with a gap between the unfolded surface frame body and the upper wall of the outer box body. The closed surface has first and second (e.g., upper and lower) edges that are bonded to a sliding plate or sheet, which is in the gap between the unfolded surface frame body and the upper wall of the outer box body. Opening and closing the inner box body drives the sliding plate or sheet to slide laterally in the gap.

Preferably, the unfolded surface frame body is substantially rectangular, with a rectangular cut-out in one end and a square opening near an edge of an opposite end, in which the length of the opening is not less than the depth of the cut-out. The sliding plate or sheet is rectangular or substantially rectangular and has a length and a width less than the corresponding length and width of the unfolded surface frame body, and the sliding plate or sheet has a bent card at one end and a locking strip at an opposite end. The card is perpendicularly connected to the sliding plate or sheet, and passes through the cut-out. The locking strip is in the opening.

Preferably, the unfolded surface is divided into a plurality of equally-sized unfolded sub-surfaces. The closed surface is also divided into an equal number of closed sub-surfaces. Each closed sub-surface has a width that is greater than that of each unfolded sub-surface. Each closed sub-surface covers a corresponding one of the unfolded sub-surfaces.

Preferably, there are five unfolded sub-surfaces, namely a first unfolded sub-surface, a second unfolded sub-surface, a third unfolded sub-surface, a fourth unfolded sub-surface, and a fifth unfolded sub-surface. Each of the unfolded sub-surfaces includes two equal-length slits in a first side near an upper edge and a lower edge of the unfolded sub-surface, an unfolded sub-surface connecting strip on an opposite side of the unfolded sub-surface, and a main body in a middle of the unfolded sub-surface. The unfolded sub-surface bodies are the first unfolded sub-surface body, the second unfolded sub-surface body, the third unfolded sub-surface body, the fourth unfolded sub-surface body, and the fifth unfolded sub-surface body.

There are also five closed sub-surfaces, namely a first closed sub-surface, a second closed sub-surface, a third closed sub-surface, a fourth closed sub-surface, and a fifth closed sub-surface. Each of the closed sub-surfaces includes two equal-length slits in a first side near an upper edge and a lower edge of the closed sub-surface, a closed sub-surface connecting strip on an opposite side of the closed sub-surface, and a main body in a middle of the closed sub-surface. The five main bodies of the closed sub-surfaces are the first closed sub-surface body, the second closed sub-surface body, the third closed sub-surface body, the fourth closed sub-surface body, and the fifth closed sub-surface body. Among them, the first closed sub-surface body includes a protruding part between the two slits in the first side of the first closed sub-surface.

The first side of the first closed sub-surface body is inserted below the first side of the second unfolded sub-surface body, the protruding part is bonded and/or fixed to the sliding plate or sheet, and the first closed sub-surface body completely covers the first unfolded sub-surface body. The first side of the second closed sub-surface body is inserted below the first side of the third unfolded sub-surface body, and the second closed sub-surface body fully covers the second unfolded sub-surface body. The first side of the third closed sub-surface body is inserted below the first side of the fourth unfolded sub-surface body, and the third closed sub-surface body fully covers the third unfolded sub-surface body. The first side of the fourth closed sub-surface body is inserted below the first side of the fifth unfolded sub-surface body, the fourth closed sub-surface body completely covers the fourth unfolded sub-surface body, and the fifth closed sub-surface body completely covers the fifth unfolded sub-surface body.

Preferably, the outer box body has no side wall at one end. The inner box body has a size that is compatible with that of the outer box body. The inner box body has no upper wall, and the inner box body has a side wall with a horseshoe-shaped opening therein and a pull tab in the horseshoe-shaped cutout.

A second aspect of the present invention concerns a method of preparing the packaging box for showing different images when open and closed, that includes the following steps.
S1: forming a rectangular cut-out in one end of a first rectangular sheet, and forming a square opening near the edge of the opposite end of the first rectangular sheet, with the length of the opening being not less than the depth of the cut-out, to obtain an unfolded surface frame body; cutting the unfolded surface into five equal-area unfolded sub-surfaces, and cutting the two equal-length slits in the first side of each unfolded sub-surface near the upper and lower edges, leaving the opposite side connected without being cut as the unfolded sub-surface connecting strip; bonding the upper edges of the unfolded sub-surfaces to the upper edge of the unfolded surface frame body, and bonding the lower edges of the unfolded sub-surfaces to the lower edge of the unfolded surface frame body, with the gap between the unfolded surface frame body and the unfolded surface.
S2: forming the bent card at the one end of a second rectangular sheet, the bent card having a width less than a width of the cut-out, and making the locking strip at the opposite end of the second rectangular sheet, resulting in the sliding plate or sheet, with both a length and a width less than those of the unfolded surface frame body, and inserting the sliding plate or sheet between the unfolded surface frame body and the unfolded surface.

In the gap, the locking strip is on one side of the opening, and the card is on a same side of the cut-out.
S3: cutting the closed surface into five equal-area closed sub-surfaces, cutting two equal-length slits in the first side of each of the closed sub-surfaces, leaving the opposite side connected without cutting as the closed sub-surface connecting strip, with a protruding part remaining on the first side of the first closed sub-surface; bonding upper edges of the five closed sub-surfaces together, and bonding lower edges of the five closed sub-surfaces together to obtain the closed surface.
S4: bonding the protruding part of the first closed sub-surface body of the closed surface obtained in step S3 to the sliding plate or sheet, inserting the first side of the first closed sub-surface body under the first side of the second unfolded sub-surface body and ensuring that the first closed sub-surface body fully covers the first unfolded sub-surface body; inserting the first side of the second closed sub-surface body under the first side of the third unfolded sub-surface body and ensuring that the second closed sub-surface body fully covers the second unfolded sub-surface body; inserting the first side of the third closed sub-surface body under the first side of the fourth unfolded sub-surface body and ensuring that the third closed sub-surface body fully covers the third part of the bod; inserting the first side of the fourth closed sub-surface body under the first side of the fifth unfolded sub-surface body and ensuring that the fourth closed sub-surface body fully covers the fourth unfolded sub-surface body and the fifth closed sub-surface body fully covers the fifth unfolded sub-surface body.
S5: attaching the upper and lower edges of the unfolded surface frame body obtained in step S1 to the upper wall of the outer box body. The unfolded surface is in the display window.
S6: bonding walls of the outer box body together to form an outer box body without a side wall at one end, fitting the inner box body in the outer box body such that the card is outside a side wall of the inner box body and inside a side wall of at an opposite end of the outer box body, and the locking strip is inside the inner box body to obtain the packaging box.

A third aspect of the present invention discloses the use of the packaging box showing different images when open and closed for cigarette packaging.

Preferably, ten packs of cigarettes are contained in the inner box body of the packaging box.

The packaging box of the present invention for holding ten packs of cigarettes shows different images on the unfolded surface or the closed surface in the display window.

The inner box body of the packaging box is inside the outer box body, and ten packages of cigarettes (ordinary cigarette packs) are inside the inner box body when the packaging box is in a packaged state. At this point, as the closed surface covers the unfolded surface, and the overall image on the closed surface is displayed in the display window. Pull the pull tab in the horseshoe-shaped opening, and partially remove the inner box from the outer box. After removing the inner box a certain distance, the inner side wall of the inner box contacts the locking strip on the sliding plate or sheet, and continued removal of the inner box drives the sliding plate or sheet to move with it. At this point, the first, second, third, and fourth closed sub-surface bodies are slowly inserted beneath the second, third, fourth, and fifth unfolded sub-surface bodies, and the inner box body can continue to be removed until the locking strip is caught by the outer edge of the opening. At this point, the first, second, third, and fourth closed sub-surface bodies are fully inserted beneath the second, third, fourth, and fifth unfolded sub-surface bodies, and the overall image on the unfolded surface is displayed in the display window. At this point, one or several packs of cigarettes can be taken out.

Push the inner box body back into the outer box body. After the inner box body moves a certain distance into the outer box body, the inner side wall of the inner box body catches the card on the sliding plate or sheet, and the inner box body drives the sliding plate or sheet to move into the outer box body. At this point, the first, second, third, and fourth closed sub-surface bodies slowly move out from beneath the second, third, fourth, and fifth unfolded sub-surface bodies. The main bodies of the first, second, third, fourth and fifth unfolded sub-surface bodies are gradually covered by the main bodies of the first, second, third, fourth and fifth closed sub-surface bodies. As the inner box body continues to move into the outer box body, the card touches the inner surface on the side wall of the outer box body. At this point, the first, second, third, and fourth closed sub-surface bodies are completely out from beneath the second, third, fourth, and fifth unfolded sub-surface bodies, and the first, second, third, fourth and fifth unfolded sub-surface bodies are completely covered by the first, second, third, fourth and fifth closed sub-surface bodies. The inner box body is completely inside the outer box body, and the entire packaging box is in a closed state. At this point, the overall image on the closed surface is displayed in the display window.

Therefore, the packaging box of the present invention can, by opening and closing the inner box body, move the closed surface laterally to display the image on the unfolded surface or the image on the closed surface in the display window. That is, two different images can be presented in the display window 10.

Beneficial effects of the present invention:

The packaging box of the present invention can display different images on the surface of the packaging box (in a display window) by opening and closing the inner box body. The packaging box of the present invention may also, through ingenious design, present different dynamic images on the surface (in the display window) of the packaging box, thereby giving consumers an interesting spatial dynamic experience and visual impact. The packaging box of the present invention is used for the purpose of holding multiple (e.g., ten) packages of ordinary cigarettes in the inner box, and is well-received by consumers.

### BRIEF DESCRIPTION OF THE DRAWINGS

FIG. 1 is an overall schematic diagram of the packaging box of the present invention that shows different images when open and closed.

FIG. 2 is a schematic diagram of the inner box body of the packaging box of the present invention.

FIG. 3 is a schematic diagram of the unfolded surface frame body of the packaging box of the present invention.

FIG. 4 is a schematic diagram of the sliding plate or sheet of the packaging box of the present invention.

FIG. 5 is a bottom view of the unfolded surface frame and the sliding plate or sheet of the packaging box of the present invention.

FIG. 6 is a perspective view of FIG. 5.

FIG. 7 is a schematic diagram of the overall unfolded surface formed by bonding the upper and lower edges of the main body of the five unfolded sub-surfaces of the packaging box of the present invention together.

FIG. 8 is a schematic diagram of the main body of the five closed sub-surfaces of the packaging box of the present invention.

FIG. 9 is a schematic diagram of the integral closed surface formed by the bonding of the upper and lower edges of the five closed sub-surface bodies in FIG. 8 respectively.

FIG. 10 is a schematic diagram of the relative positions of the overall unfolded surface in FIG. 7 and the overall closed surface in FIG. 9 in the packaging box of the present invention.

FIG. 11 is a schematic diagram of the combination of the unfolded surface frame and the sliding plate or sheet after the unfolded surface of FIG. 10 is bonded to the unfolded surface frame and the closed surface is bonded to the sliding plate or sheet, in which the five closed sub-surface bodies respectively partially cover the five unfolded sub-surface bodies.

FIG. 12 is a schematic diagram of the unfolded outer box body of the packaging box of the present invention.

FIG. 13 is a schematic diagram of the fully open state of the inner box of the present packaging box.

FIGS. 14-18 are photographs of the packaging box of the present invention in different states.

The identified features in the attached figures are: 1. Outer box body; 10. Display window; 2. Inner box body; 21. Horseshoe-shaped cutout; 22. Pull tab; 3. Unfolded surface frame; 31. Cut-outs; 32. Opening; 4. Sliding plate or sheet; 41. Card; 42. Locking strip; A. Unfolded surface; B. Closed surface; A1. First unfolded sub-surface; A2. Second unfolded sub-surface; A3. Third unfolded sub-surface; A4, Fourth unfolded sub-surface; A5, Fifth unfolded sub-surface; a1. The main body of the first unfolded sub-surface; a2. The main body of the second unfolded sub-surface; a3. The main body of the third unfolded sub-surface; a4. The main body of the fourth unfolded sub-surface; a5, The main body of the fifth unfolded sub-surface; M1. Edge of the unfolded surface; M2, Lower edge of the unfolded surface; M3, split-unfolded surface connecting strip; B1. First closed sub-surface; B2. Second closed sub-surface; B3. Third closed sub-surface; B4, Fourth closed sub-surface; B5, Fifth closed sub-surface; b1. The main body of the first closed sub-surface; b2. The main body of the second closed sub-surface; b3. The main body of the third closed sub-surface; b4. The main body of the fourth closed sub-surface; b5, The main body of the fifth closed sub-surface; N1. Edge of the closed surface; N2. Lower edge of the closed sub-surfaces; N3. Split-closed surface connecting strip.

### DETAILED DESCRIPTION

In order to make the objectives, technical solutions, and advantages of the present invention clearer, further details of the invention are provided below with reference to the drawings and embodiments. All other embodiments obtained by those skilled in the art without making creative efforts based on the embodiments of the present invention fall within the scope of protection of the present invention.

It should be understood in the description of the present invention that the terms “center,” “vertical,” “horizontal,” “length,” “width,” “thickness” and “up,” “down,” “before” and “after,” “left,” “right” and “vertical,” “level,” “top,” “bottom,” “inside” and “outside” indicating a location or a positional relation based on the location or position shown in the drawings, are only for the purpose of facilitating and/or simplifying the description of the invention, and do not indicate or imply that the device described must have a particular orientation, or be constructed or operated in a particular orientation, and therefore should not be construed as a limitation of the invention.

Furthermore, the terms “first,” “second,” “third,” “fourth,” “fifth,” etc., are used for descriptive purposes only and should not be construed as indicating or suggesting relative importance or implicitly indicating the number of technical features indicated.

In the present invention, unless otherwise expressly specified and limited, terms such as “installed,” “connected,” “linked,” “fixed,” “bonded,” etc. should be understood in a broad sense, for example, they can be connected or integrated, or they can be detachably connected. For those skilled in the art, the specific meanings of the above terms in the present invention can be understood according to the specific circumstances.

In this specification, the indicative representation of the terms should not be construed as necessarily referring to the same embodiments or examples. Moreover, specific features, structures, materials or characteristics described herein may be combined in an appropriate manner in any of one or more embodiments or examples. Furthermore, a person skilled in the art may combine different embodiments or examples described in this specification.

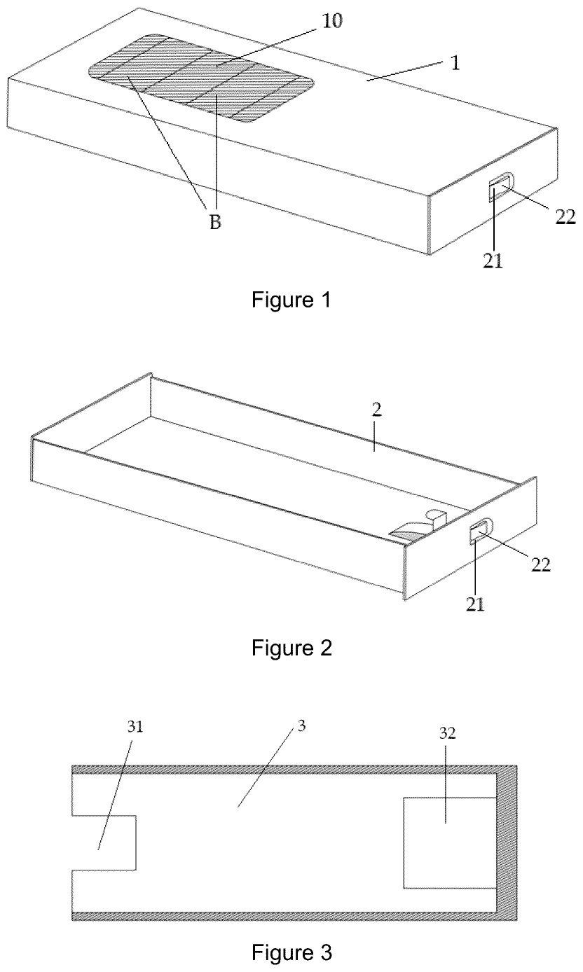

As shown in FIGS. 1-13, a packaging box of the present invention showing different images when open and closed comprises an outer box body 1 and an inner box body 2; a display window 10 on the upper face of the outer box body 1; and different images displayed in the display window 10 on the unfolded surface A and the closed surface B; where the unfolded surface A is fixed in display window 10; and opening and closing the inner box body 2 drives the lateral movement of the closed surface B to display the image on the unfolded surface A or the image on the closed surface B in the display window 10.

The upper and lower edges of the unfolded surface A are respectively bonded to the unfolded surface frame body 3, the upper and lower edges of the unfolded surface frame body 3 are bonded to the inner surface of the upper face of the outer box body 1, and there is a gap between the unfolded surface frame body 3 and the inner surface of the upper face of the outer box body 1. The upper and lower edges of the closed surface B are bonded to the upper surface of the sliding plate or sheet 4 (hereinafter, the “sliding plate”), which is in the gap between the unfolded surface frame 3 and the inner surface of the upper wall of the outer box body 1. Opening and closing the inner box body 2 drives the sliding plate 4 to slide laterally in the aforementioned gap.

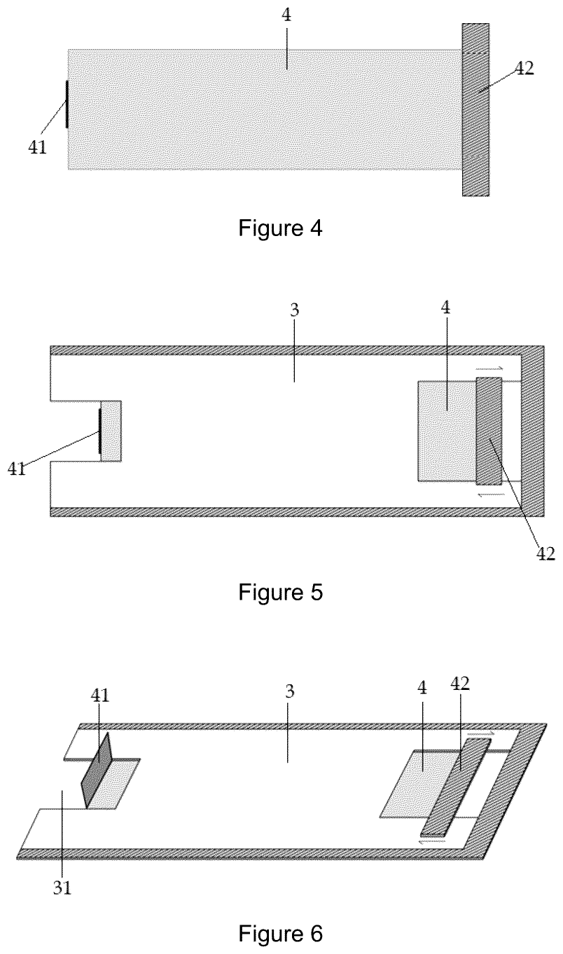

As shown in FIG. 3, the unfolded surface frame body 3 is substantially rectangular. There is a rectangular cut-out 31 in the middle of one end (the left end, as shown in the drawing), and there is a square opening 32 near the edge of the opposite end (the right end, as shown in the drawing). The length of the opening 32 is not less than the depth of the cut-out 31. As shown in FIG. 4, the sliding plate 4 is also substantially rectangular, and has a length and a width that are less than the length and width of the unfolded surface frame body 3. The inner end of the sliding plate 4 (on the left in the drawing) has a vertical bent piece or card 41, and the opposite end of the sliding plate 4 (on the right in the drawing) includes a locking strip 42 having a length greater than the width of the sliding plate 4. The card 41 is fixedly and perpendicularly connected to the sliding plate 4, and passes through the cut-out 31. The locking strip 42 is in the opening 32, or on the opposite surface of the unfolded surface frame body 3 from the main body of sliding plate 4, and the length of the locking strip 42 can be greater than the length of the opening 32.

The unfolded surface A is divided into several equally-sized unfolded sub-surfaces A1, A2, A3, . . . . The closed surface B is also divided similarly to the unfolded sub-surfaces A1, A2, A3, . . . into an equal number of closed sub-surfaces B1, B2, B3, . . . . Each closed sub-surface B1, B2, B3, . . . has a width slightly greater than that of each unfolded sub-surface A1, A2, A3, . . . . Each closed sub-surface B1, B2, B3, . . . has a width sufficient to cover each of the unfolded sub-surfaces A1, A2, A3, . . . .

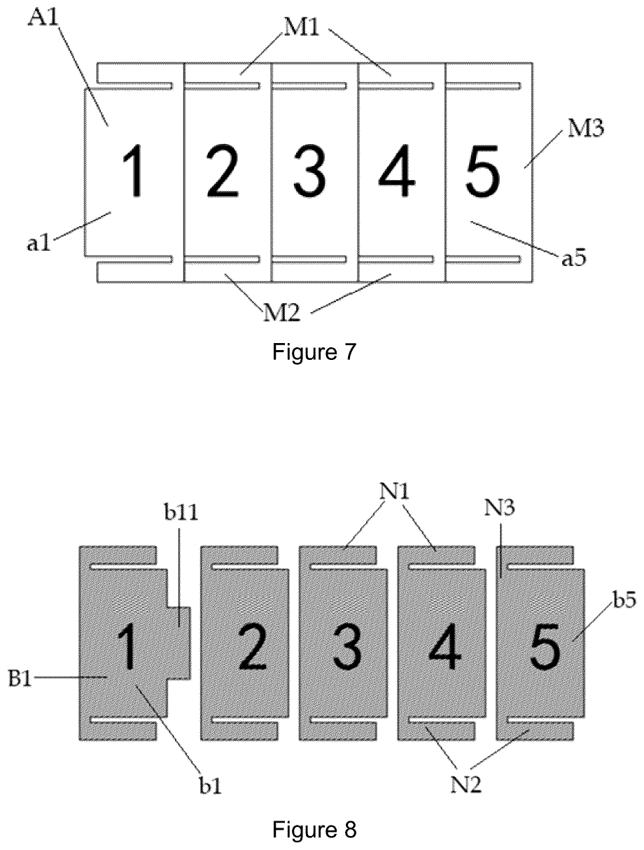

In an embodiment of the present invention, as shown in FIG. 7, there are five unfolded sub-surfaces A1, A2, A3, . . . , namely, the first unfolded sub-surface A1, the second unfolded sub-surface A2, the third unfolded sub-surface A3, the fourth unfolded sub-surface A4, and the fifth unfolded sub-surface A5 (the labels A2, A3, A4, A5 are not marked in the drawing). Each of the unfolded sub-surfaces includes two equal-length slits starting from one side or edge, adjacent to the upper edge M1 and the lower edge M2 of the unfolded sub-surface. The opposite side or edge of the unfolded sub-surface includes an unfolded sub-surface connecting strip M3, and the unfolded sub-surface includes a main body in the middle (e.g., between the two slits). The five unfolded sub-surface bodies are the first unfolded sub-surface body a1, the second unfolded sub-surface body a2, the third unfolded sub-surface body a3, the fourth unfolded sub-surface body a4, and the fifth unfolded sub-surface body a5 (the labels a2, a3, a4, and a5 are not marked in the drawing).

In embodiments of the present invention, as shown in FIG. 8, there are also five closed sub-surfaces B1, B2, B3, . . . , namely, the first closed sub-surface B1, the second closed sub-surface B2, the third closed sub-surface B3, the fourth closed sub-surface B4, and the fifth closed sub-surface B5 (the labels B2, B3, B4, B5 are not marked in the drawing). Each of the closed sub-surfaces includes two equal-length slits starting from one side or edge, adjacent to the upper edge N1 and the lower edge N2 of the closed sub-surface. The opposite side or edge of the closed sub-surface includes a closed sub-surface connecting strip N3, and the closed sub-surface includes a main body in the middle (e.g., between the two slits). The five main bodies of the closed sub-surfaces are the first closed sub-surface body b1, the second closed sub-surface body b2, the third closed sub-surface body b3, the fourth closed sub-surface body b4, and the fifth closed sub-surface body b5 (the labels b2, b3, b4, and b5 are not marked in the drawing). Among them, the first closed sub-surface b1 includes a protruding part b11 in the middle on the one side or edge (e.g., between the two slits).

The one side or edge of the first closed sub-surface body b1 (on the right in the drawing) is inserted below the one side or edge of the second split unfolded surface body a2 (on the left in the drawing), the protruding part b11 is bonded and/or fixed to the sliding plate 4, and the first closed sub-surface body b1 completely covers the first unfolded sub-surface body a1. The one side or edge of the second closed sub-surface body b2 (on the right in the drawing) is inserted below the one side or edge of the third unfolded sub-surface body a3 (on the left in the drawing), and the second closed sub-surface body b2 fully covers the second unfolded sub-surface body a2. The one side or edge of the third closed sub-surface body b3 (on the right in the drawing) is inserted below the one side or edge of the fourth unfolded sub-surface body a4 (on the left in the drawing), and the third closed sub-surface body b3 fully covers the third unfolded sub-surface body a3. The one side or edge of the fourth closed sub-surface body b4 (on the right in the drawing) is inserted below the one side or edge of the fifth unfolded sub-surface body a4 (on the left in the drawing), the fourth closed sub-surface body b4 completely covers the fourth unfolded sub-surface body a4, and the fifth closed sub-surface body b5 completely covers the fifth unfolded sub-surface body a5.

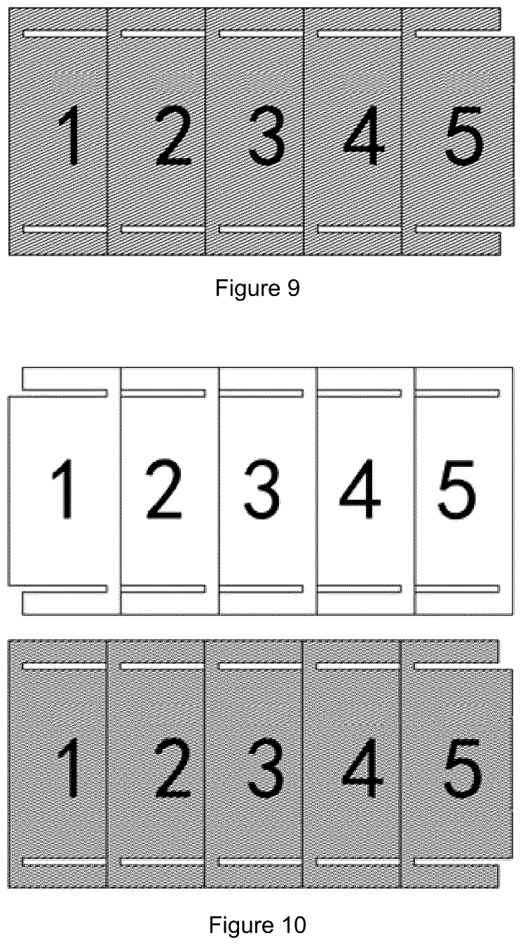

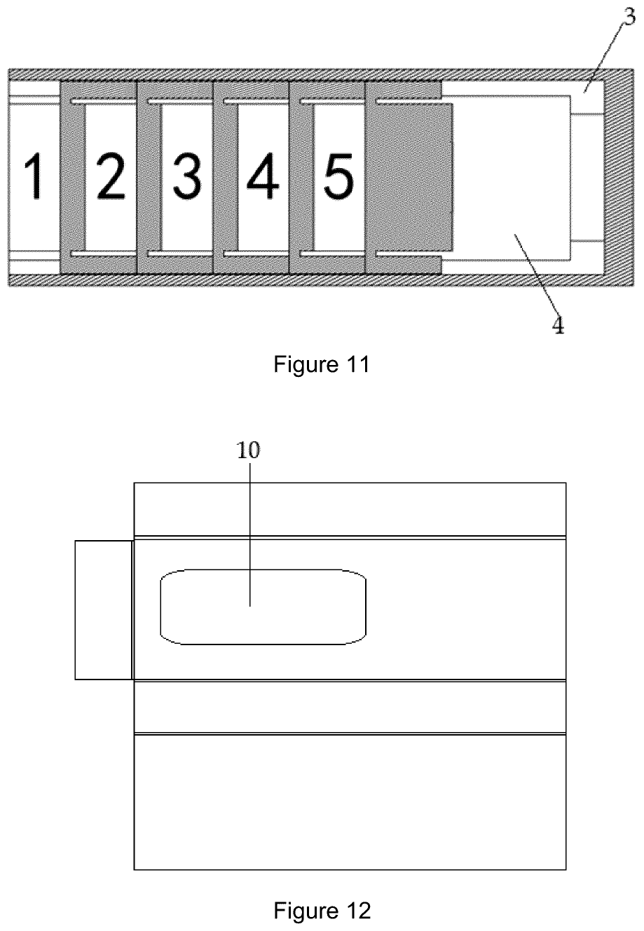

FIG. 10 is a schematic diagram of the relative positions of the overall unfolded surface of FIG. 7 and the overall closed surface of FIG. 9 in the packaging box of the present invention. FIG. 11 is a schematic diagram of the combination of the unfolded surface frame and the sliding plate after the unfolded surface of FIG. 10 is bonded to the unfolded surface frame and the closed surface is bonded to the sliding plate. Among them, the five closed sub-surface bodies respectively partially cover the five unfolded sub-surface bodies.

The outer box body 1 may have no side wall where the inner box body 2 enters and exits, as shown in the diagram of the outer box body of the packaging box of the present invention in FIG. 12, although the outer box body 1 may have a hinged side wall with an insertable tab on the edge opposite from the hinge. The size of the inner box body 2 is compatible with (e.g., slightly smaller than) that of the outer box body 1. The inner box body 2 may have no upper wall (e.g., facing the unfolded surface frame 3 and the sliding plate 4), and outer side wall of the inner box body 2 may have a horseshoe-shaped opening 21 therein (e.g., in the middle), with a pull tab 22 in or through the opening 21; see FIG. 2.

The preparation method of the packaging box of the present invention for showing different images when open and closed may comprise the following steps.
S1: Form a rectangular cut-out 31 in the middle of one end of a rectangular sheet, and form a square opening 32 near the edge of the opposite end, with the length of the opening 32 being not less than the depth of the cut-out 31, to obtain the unfolded surface frame body 3, as shown in FIG. 3. Cut the unfolded surface A into five equal-area unfolded sub-surfaces A1, A2, A3, A4, and A5. Cut two equal-length slits from one side or edge (e.g., the inner edge), adjacent to upper and lower edges of each of the five unfolded sub-surfaces, and keep the opposite side or edge connected without cutting to form the unfolded sub-surface connecting strips M3. Sequentially bond the edges M1 of the five unfolded sub-surfaces together as shown in FIG. 7, then bond the upper edges M1 that are bonded together to the upper edge of the unfolded frame 3. Bond the lower edges M2 of the five unfolded sub-surfaces together in sequence, and then bond the lower edges M2 that are bonded together to the lower edge of the unfolded frame 3, with a gap between the unfolded surface frame body 3 and the unfolded surface, as shown in FIGS. 7 and 11.
S2: Fold card 41 perpendicularly downward from the inner end of the rectangular piece, with the width of card 41 slightly less than the width of the cut-out 31, and make a locking strip 42 at the outer end of the rectangular piece, with the locking strip 42 having a greater length than the length or width of the opening 32, resulting in a sliding plate 4 with both length and width less than those of the unfolded surface frame body 3, as shown in FIG. 4. Insert the sliding plate 4 into the gap between the unfolded surface frame body 3 and the unfolded surface, where the locking strip 42 is at the left edge of the opening 32, and the locking strip 42 is below the square of the opening 32, so that the sliding plate 4 and the unfolded surface frame body 3 are locked together, and the card 41 is in (e.g., at the inner edge of) the cut-out 31. In FIGS. 5 and 6, where the unfolded surface frame body 3 and the sliding plate 4 are combined, the sliding plate 4 can slide laterally a certain distance.
S3: Cut the closed surface B into five equal-area closed sub-surfaces B1, B2, B3, B4 and B5. Cut two equal-length slits from one side or edge (e.g., the outer edge) of each of the five closed sub-surfaces, leaving the opposite side connected together without being cut to form the closed sub-surface connecting strips N3. The protruding part b11 remains on the one side or edge of the first closed sub-surface B1, as shown in FIG. 8. The upper edges N1 of the five closed sub-surfaces are sequentially bonded together, and the lower edges N2 of the five closed sub-surfaces are sequentially bonded together to obtain the overall closed surface B, as shown in FIG. 9.
S4: Bond the protruding part b11 in the middle of the first closed sub-surface body b1 of the closed surface B obtained in step S3 to the sliding plate 4, while inserting the one side or edge of the first closed sub-surface body b1 of the closed surface under the one side or edge of the second unfolded sub-surface body a2 and ensuring that the first closed sub-surface body b1 of the closed surface fully covers the first unfolded sub-surface body a1. Insert the one side or edge of the second closed sub-surface body b2 under the one side or edge of the third unfolded sub-surface body a3 and ensure that the second closed sub-surface body b2 fully covers the second unfolded sub-surface body a2. Insert the one side or edge of the third closed sub-surface body b3 under the one side or edge of the fourth unfolded sub-surface body a4 and ensure that the third closed sub-surface body b3 fully covers the third unfolded sub-surface body a3. Insert the one side or edge of the fourth closed sub-surface body b4 under the one side or edge of the fifth unfolded sub-surface body a4 and ensure that the fourth closed sub-surface body b4 fully covers the fourth unfolded sub-surface body a4 and the fifth closed sub-surface body b5 fully covers the fifth unfolded sub-surface body a5, as shown in FIG. 11.

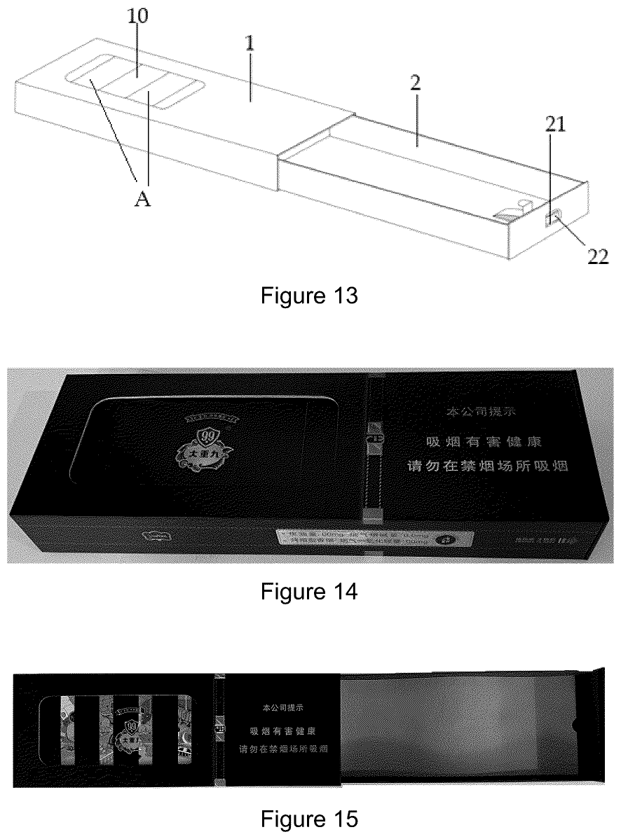

FIG. 11 is a schematic diagram of the combination of the unfolded surface frame body 3 and the sliding plate 4 after the overall unfolded surface A is bonded to the unfolded surface frame body 3 and the overall closed surface B is bonded to the sliding plate 4. Among them, the five closed sub-surface bodies B1-B5 partially cover the five unfolded sub-surface bodies A1-A5 in the schematic diagram. FIG. 10 shows a schematic diagram of the relative positions of the overall unfolded surface A and the overall closed surface B when combined with the unfolded surface frame body 3 and the sliding plate 4.
S5: The upper and lower edges of the unfolded surface frame body 3 obtained in step S4 (the shaded part of the upper edge and the shaded part of the lower edge in FIG. 11) are bonded to the inner surface of the upper wall of the outer box 1. The overall unfolded surface A should be in the display window 10.
S6: Bond the five walls of the outer box body 1 shown in FIG. 12 together (optional bonding tabs along edges of the side walls, and optionally, the upper wall) to form an outer box body 1 without one side wall, and fit the inner box body 2 in the outer box body 1 (e.g., through the opening in outer box body 1 formed by the missing side wall) such that the card 41 is outside the inner side wall of the inner box body 2 and inside the smallest side wall of the outer box body 1, and the locking strip 42 is inside the inner box body 2. This results in formation of the packaging box. The overall schematic diagram of the packaging box of the present invention is shown in FIG. 1, and the schematic diagram of the fully open state of the inner box of the packaging box of the present invention is shown in FIG. 13.

The packaging box of the present invention, which shows different images by opening and closing, is used for cigarette packaging, and the inner box body 2 of the cigarette packaging box may contain a plurality (e.g., ten) packs of cigarettes.

The packaging box of the present invention for cigarette packaging has been industrially produced and has entered the market for sale. FIGS. 14-18 show physical photographs of the packaging box of the present invention in different states.

The packaging box of the present invention and method of showing different images on the unfolded surface A or the closed surface B in the display window 10 may operate as follows.

As shown in the photo in FIG. 14, the inner box body 2 of the packaging box is inside the outer box body 1, and the packaging box is in a closed state. At this point, as the closed surface B covers the unfolded surface A, and what is shown in the display window 10 is the overall image on the closed surface B.

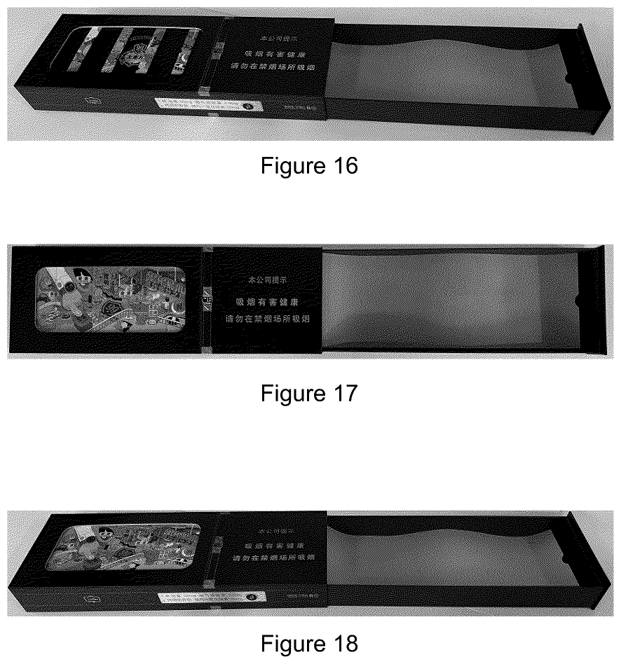

Pull the pull tab 22 in the horseshoe-shaped opening 21, and partially remove the inner box 2 from the outer box 1. After withdrawing the inner box 2 a certain distance, the inner side wall of the inner box 2 contacts the locking strip 42 on the sliding plate 4, and the inner box 2 drives the sliding plate 4 to move to the open (missing) side wall of the outer box 1. At this point, the first, second, third, and fourth closed sub-surface bodies (b1, b2, b3, and b4) begin to slide beneath the second, third, fourth, and fifth unfolded sub-surface bodies (a2, a3, a4, and a5), as shown in FIGS. 15 and 16, with part of the closed surface B covering the unfolded surface A. As the inner box body 2 continues to be removed, the locking strip 42 is caught by the inner edge of the opening 32, at which point the first, second, third and fourth closed sub-surface bodies (b1, b2, b3 and b4) are fully inserted under the second, third, fourth and fifth unfolded sub-surface bodies (a2, a3, a4 and a5). The overall image on the unfolded surface A is displayed in the display window 10, as shown in FIGS. 17 and 18.

Push the inner box 2 back into the outer box 1. After the inner box 2 moves a certain distance into the outer box 1, the inner side wall of the inner box 2 catches the card 41 on the sliding plate 4, and the inner box 2 drives the sliding plate 4 to move to into the outer box 1. At this point, the first, second, third, and fourth closed sub-surface bodies (b1, b2, b3, and b4) slowly move out from beneath the second, third, fourth, and fifth unfolded sub-surface bodies (a2, a3, a4, and a5). The main bodies of the first, second, third, fourth and fifth unfolded sub-surfaces (a1, a2, a3, a4 and a5) are gradually covered by the main bodies of the first, second, third, fourth and fifth closed sub-surfaces (b1, b2, b3, b4 and b5), as shown in FIGS. 15 and 16. As the inner box 2 continues to move into the outer box 1, the card 41 eventually touches the wall on the left side of the outer box 1. At this point the first, second, third, and fourth closed sub-surface bodies (b1, b2, b3, and b4) move out completely from beneath the second, third, fourth, and fifth part unfolded sub-surface bodies (a2, a3, a4, and a5). The first, second, third, fourth and fifth unfolded sub-surface bodies (a1, a2, a3, a4 and a5) are completely covered by the first, second, third, fourth and fifth closed sub-surface bodies (b1, b2, b3, b4 and b5), the inner box body 2 is completely inside the outer box body 1, and the entire packaging box is in a closed state. At this point, the overall image on the closed surface B is displayed in the display window 10, as shown in the photo in FIG. 14.

Therefore, the packaging box of the present invention can move the closed surface B laterally by opening and closing the inner box body 2, and display the image on the unfolded surface A or the image on the closed surface B in the display window 10. That is, two different images can be presented in the display window 10.

The image on the closed surface B of the present invention is the “Great Double Nine” pattern, as shown in FIG. 14. The image on the unfolded surface A of the present invention is a cartoon pattern, as shown in FIGS. 17 and 18. The packaging box of the present invention shows two different images in the display window by opening and closing the inner box body. The present invention can also integrate the image on the overall unfolded surface A and the image on the overall closed surface B, and present a dynamic picture in the display window by moving the closed surface B laterally.

The above embodiments are not limited to the present invention, nor is the present invention limited to the examples mentioned above. Changes, modifications, additions or substitutions made by a person skilled in the art within the substance of the invention also fall within the scope of protection of the invention.

What is claimed is:

1. A packaging box showing different images when open and closed, comprising an outer box body and an inner box body, a display window on an upper face of the outer box body, and different images displayed in the display window on an unfolded surface or a closed surface, wherein:
the unfolded surface is fixed in the display window, and opening and closing the inner box body drives lateral movement of the closed surface to display a first image on the unfolded surface or a second image on the closed surface in the display window,
the unfolded surface has first and second edges bonded to an unfolded surface frame body,
the unfolded surface frame body has first and second edges bonded to an upper wall of the outer box body, with a first gap between the unfolded surface frame body and the upper wall of the outer box body,
the closed surface has first and second edges bonded to a sliding plate or sheet,
the sliding plate or sheet is in the first gap between the unfolded surface frame body and the upper wall of the outer box body, and opening and closing the inner box body drives the sliding plate or sheet to slide laterally in the gap′
the unfolded surface frame body is substantially rectangular, with a rectangular cut-out in one end and a square opening near an edge of an opposite end,
the opening has a length not less than a depth of the cut-out,
the sliding plate or sheet is rectangular and has a length and a width less than a corresponding length and a corresponding width of the unfolded surface frame body,
the sliding plate or sheet has a bent card at one end and a locking strip at an opposite end,
the card passes through the cut-out and is perpendicularly connected to the sliding plate or sheet, and
the locking strip is in the opening.

2. The packaging box according to claim 1, wherein the unfolded surface is divided into a plurality of equally-sized unfolded sub-surfaces, the closed surface is divided into an equal number of closed sub-surfaces, each closed sub-surface has a width greater than that of each unfolded sub-surface, and each closed sub-surface covers a corresponding one of the unfolded sub-surfaces.

3. The packaging box according to claim 2, wherein the plurality of unfolded sub-surfaces comprises a first unfolded sub-surface, a second unfolded sub-surface, a third unfolded sub-surface, a fourth unfolded sub-surface, and a fifth unfolded sub-surface, each of the unfolded sub-surfaces includes two equal-length slits in a first side near an upper edge and a lower edge of the unfolded sub-surface, an unfolded sub-surface connecting strip on an opposite side of the unfolded sub-surface, and a main body in a middle of the unfolded sub-surface;
the equal number of closed sub-surfaces comprise a first closed sub-surface, a second closed sub-surface, a third closed sub-surface, a fourth closed sub-surface, and a fifth closed sub-surface, each of the closed sub-surfaces includes two equal-length slits in a first side near an upper edge and a lower edge of the closed sub-surface, a closed sub-surface connecting strip on an opposite side of the closed sub-surface, and a main body in a middle of the closed sub-surface, and the first closed sub-surface body has a protruding part between the two slits in the first side of the first closed sub-surface;
the first side of the main body of the first closed sub-surface is inserted below the first side of the main body of the second unfolded sub-surface, the protruding part is bonded and/or fixed to the sliding plate or sheet, the main body of the first closed sub-surface completely covers the main body of the first unfolded sub-surface, the first side of the main body of the second closed sub-surface is inserted under the first side of the main body of the third unfolded sub-surface, the main body of the second closed sub-surface fully covers the main body of the second unfolded sub-surface, the first side of the main body of the third closed sub-surface is inserted below the first side of the main body of the fourth unfolded sub-surface, the main body of the third closed sub-surface fully covers the main body of the third unfolded sub-surface, the first side of the main body of the fourth closed sub-surface is inserted below the first side of the main body of the fifth unfolded sub-surface, the main body of the fourth closed sub-surface fully covers the main body of the fourth unfolded sub-surface, and the main body of the fifth closed sub-surface fully covers the main body of the fifth part sub-surface.

4. The packaging box according to claim 1, wherein the outer box body has no side wall at one end, the inner box body has a size compatible with that of the outer box body, the inner box body has no upper wall, and the inner box body has a side wall with a horseshoe-shaped cutout therein and a pull tab in the horseshoe-shaped cutout.

5. A method for preparing the packaging box for showing different images when open and closed according to claim 1, comprising:
forming the rectangular cut-out in one end of a first rectangular sheet, and forming the square opening in an opposite end of the first rectangular sheet to obtain the unfolded surface frame body; cutting the unfolded surface into five equally-sized unfolded sub-surfaces, and cutting two equally-sized slits in a first side of each unfolded sub-surface near first and second edges of each unfolded sub-surface, leaving an opposite side of each unfolded sub-surface connected as an unfolded sub-surface connecting strip; bonding first edges of the unfolded sub-surfaces to a first edge of the unfolded surface frame body, and bonding second edges of the unfolded sub-surfaces to a second edge of the unfolded surface frame body, with a second gap between the unfolded surface frame body and the unfolded surface;
forming the bent card at one end of a second rectangular sheet, with the width of the bent card less being than that of the cut-out, and making the locking strip at an opposite end of the second rectangular sheet, resulting in the sliding plate or sheet; and inserting the sliding plate or sheet into the second gap between the unfolded frame and the unfolded surface, wherein the locking strip is on one side of the opening and the bent card is on one side of the cut-out;
cutting the closed surface into five equal-area closed sub-surfaces, cutting two equal-length slits in a first side of each of the closed sub-surfaces, leaving an opposite side of each of the closed sub-surfaces connected together without being cut as a closed sub-surface connecting strip, with a protruding part on the first side of a first one of the closed sub-surfaces; bonding upper edges of the five closed sub-surfaces together, and bonding lower edges of the closed sub-surfaces together to obtain the closed surface;
bonding the protruding part to the sliding plate or sheet, inserting the first side of a main body of the first one of the closed sub-surfaces under the first side of a main body of a second one of the unfolded sub-surfaces and ensuring that the main body of the first one of the closed sub-surfaces fully covers the main body of a first one of the unfolded sub-surfaces; inserting the first side of a main body of a second one of the closed sub-surfaces under the first side of a main body of a third one of the unfolded sub-surfaces and ensuring that the main body of the second one of the closed sub-surfaces fully covers the main body of the second one of the unfolded sub-surfaces; inserting the first side of a main body of a third one of the closed sub-surfaces under the first side of a main body of a fourth one of the unfolded sub-surfaces and ensuring that the main body of the third one of the closed sub-surfaces fully covers the main body of the third one of the unfolded sub-surfaces; inserting the first side of a main body of a fourth one of the closed sub-surfaces below the first side of a main body of a fifth one of the unfolded sub-surfaces and ensuring that the main body of the fourth one of the closed sub-surfaces fully covers the main body of the fourth one of the unfolded sub-surfaces and a main body of a fifth one of the closed sub-surfaces fully covers the main body of the fifth one of the unfolded sub-surfaces;
attaching first and second edges of the unfolded surface frame body to the upper wall of the outer box body so that the unfolded surface is in the display window; and
bonding walls of the outer box body together to form the outer box body without a first side wall at one end, and fitting the inner box body in the outer box body such that the bent card is outside a side wall of the inner box body and inside a second side wall at an opposite end of the outer box body, and the locking strip is inside the inner box body to obtain the packaging box.
